(19) United States
(12) Patent Application Publication
(10) Pub. No.: US 2008/0014854 A1
(43) Pub. Date: Jan. 17, 2008

(54) AIR CONDITIONING SYSTEM, METHOD, AND APPARATUS

(76) Inventor: Robert H. Tigner, Dalworthington Gardens, TX (US)

Correspondence Address: BRACEWELL & GIULIANI LLP, P.O. BOX 61389, HOUSTON, TX, 77208-1389, US

(21) Appl. No.: 11/672,543

(22) Filed: Feb. 8, 2007

Related U.S. Application Data
(60) Provisional application No. 60/771,506, filed on Feb. 8, 2006.

(51) Int. Cl. B60H 1/32

(52) U.S. Cl. 454/127; 62/331

(57) ABSTRACT

A military vehicle air conditioning system has one or more compressors, condensers, and evaporators. The evaporators are spaced apart from each other at the front and rear of the vehicle. An interior air distribution plenum is vertically flush with a lower edge of the windshield, has a single vent for the driver, and a large clearance between the plenum and the steering wheel of the vehicle. The front evaporator is adjacent the front passenger footwell and equipped with a renewable filter. The condenser is inside a rear storage compartment, and fans force air into the compartment through vents in the door, through the coils of the condenser, and then exhaust the heated air from the compartment. The fans are intermittently reversed to purge dust and debris circulated during this process.

This utility patent application claims priority to and the benefit of U.S. Provisional Patent Application No. 60/771,506, filed on Feb. 8, 2006, which is incorporated herein by reference.

### BACKGROUND OF THE INVENTION

1. Technical Field

The present invention relates in general to air conditioning systems and, in particular, to an improved system, method, and apparatus for air conditioning a land-based military vehicle such as a Humvee-type armored vehicle.

2. Description of the Related Art

Land-based military vehicles typically operate in very harsh environments. The climate control or air conditioning system used by military vehicles to increase the comfort of their occupants must be extremely rigorous and yet be serviceable by appropriate personnel when the system is in need of maintenance or repair. In addition, military vehicles and their systems must be built to withstand or survive ballistic attacks. There are numerous considerations for such military applications and although there are many workable solutions available to manufacturers of military vehicles, improved solutions would be desirable.

### SUMMARY OF THE INVENTION

Various embodiments of a system, method, and apparatus for military vehicle air conditioning are disclosed. The vehicle is equipped with a ventilation system for manipulating the temperature and comfort level inside the vehicle. The system cycles a refrigerant in a refrigeration system comprising one or more compressors, condensers, and evaporators. The evaporators are spaced apart from each other at the front and rear of the vehicle.

In one embodiment, an interior air distribution plenum is vertically flush with a lower edge of the windshield, has a single ventilation outlet for the driver, and a greater clearance between the plenum and the steering wheel of the vehicle. The front evaporator may be positioned adjacent the front passenger footwell and is equipped with a renewable filter. The tubing manifold has a reduced profile to fit through smaller armor openings in order to enhance protection of the occupants in an armored vehicle.

In another embodiment, a field serviceable condenser is located inside the rear storage compartment of the vehicle. A compartment door swings open vertically upward for complete access to and cleaning of the condenser. One or more fans are mounted to the condenser for pulling air into the compartment through vents in the door, through the coils of the condenser, and then exhausting the heated air from the compartment. The condenser also may be vertically oriented adjacent the intake vents in the side wall of the compartment. The fans are located on an opposite side of the condenser and the entire assembly is accessible through a removable panel on one side of the interior of the compartment. Because of the large amount of dust and debris circulated during this process, the fans are intermittently reversed.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the present invention, which will become apparent, are attained and can be understood in more detail, more particular description of the invention briefly summarized above may be had by reference to the embodiments thereof that are illustrated in the appended drawings which form a part of this specification. It is to be noted, however, that the drawings illustrate only some embodiments of the invention and therefore are not to be considered limiting of its scope as the invention may admit to other equally effective embodiments.

FIG. 1 is an isometric view of one type of vehicle constructed in accordance with the present invention;

FIG. 2 is an isometric view of another type of vehicle constructed in accordance with the present invention;

FIG. 3 is a schematic diagram of one embodiment of a vehicle air conditioning system constructed in accordance with the present invention;

FIG. 4 is an isometric view of one embodiment of an air flow plenum constructed in accordance with the present invention;

FIG. 5 is a sectional side view of the plenum of FIG. 4 and is constructed in accordance with the present invention;

FIG. 6 is an isometric view of one embodiment of a front passenger footwell in the interior cabin of a vehicle and is constructed in accordance with the present invention;

FIG. 7 is an isometric view of one embodiment of a front passenger footwell for the interior cabin of a vehicle and is constructed in accordance with the present invention;

FIG. 8 is an isometric view of one embodiment of a compressor valve plate constructed in accordance with the present invention;

FIG. 9 is an isometric view of one embodiment of a block fitting and charging port constructed in accordance with the present invention;

FIG. 10 is an isometric view of one embodiment of a tubing manifold constructed in accordance with the present invention;

FIG. 11 is a sectional view of the tubing manifold of FIG. 10 installed in an armored vehicle and is constructed in accordance with the present invention;

FIG. 12 is an isometric view of one embodiment of an extended pressure decay test system and a hose construction in accordance with the present invention;

FIG. 13 is a bottom view of one embodiment of a charging cap seal constructed in accordance with the present invention;

FIG. 14 is a side view of one embodiment of a condenser system constructed in accordance with the present invention;

FIG. 15 is a rear view of another embodiment of a condenser system constructed in accordance with the present invention;

FIG. 16 is front isometric view of one embodiment of an evaporator system constructed in accordance with the present invention;

FIG. 17 is a rear isometric view of the evaporator system of FIG. 16 and is constructed in accordance with the present invention;

FIGS. 18-20 are partially sectioned front, partially-sectioned side, and bottom views, respectively, of an accumulator for the evaporator system of FIGS. 16 and 17 and is constructed in accordance with the present invention;

FIG. 21 is a sectional side view of one embodiment of a receiver/dryer constructed in accordance with the present invention.

### DETAILED DESCRIPTION OF THE INVENTION

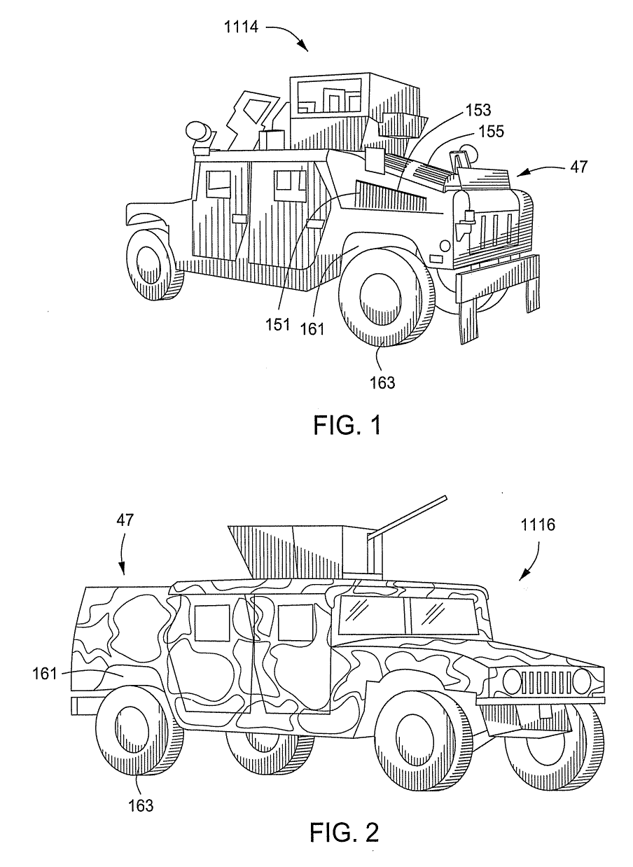

Referring to FIGS. 1 and 2, two types of land-based vehicles equipped with the system, method, and apparatus of the present invention are shown. These vehicles are commonly referred to as Humvees, and comprise military models 1114 and 1116, respectively, for transporting occupants thereof. Although only two examples of vehicles are illustrated, it should be readily apparent to one skilled in the art that there are numerous other vehicle applications, both military and civilian, suitable for the present invention.

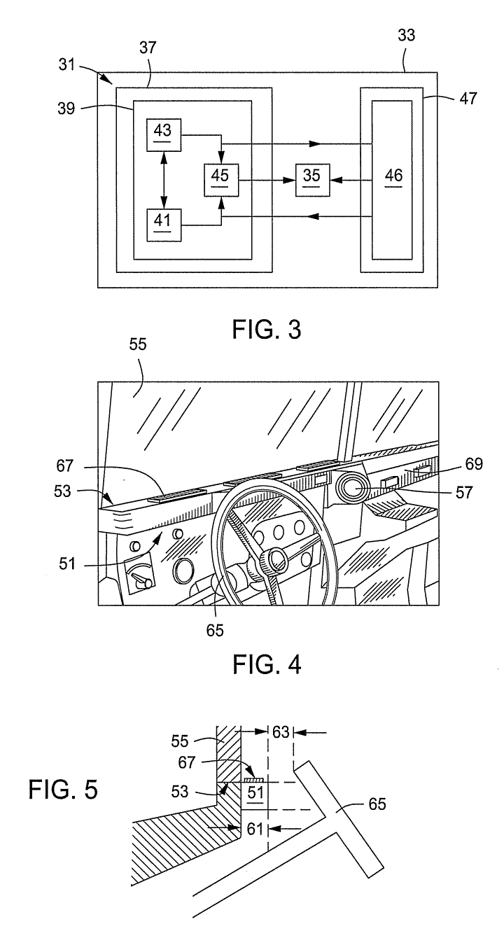

As shown in FIG. 3, one embodiment of an air conditioning system 31 for such vehicles (represented schematically by reference numeral “33”) is designed to cool the interior cabin 35 of the vehicle. The vehicle 33 is equipped with a ventilation system 37 for manipulating the temperature and comfort level in the interior cabin 35 of the vehicle 33. The air conditioning system 31 cycles a refrigerant (e.g., R134A, R22, etc.) in a refrigeration system 39. The refrigeration system 39 may comprise one or more compressors 41 (one shown), one or more condensers 43 (one shown), and one or more evaporators 45, 46 (two shown) for cycling the refrigerant in the refrigeration cycle. The evaporators 45, 46 may be spaced apart from each other, such as at the front portion and rear portion (e.g., rear cargo area 47) of the vehicle 33. Air that is chilled by the system 31 is then delivered into the interior cabin 35 through one or more plenums having outlets that are capable of redirecting the chilled air to specific locations (e.g., directly at occupants, etc.).

Referring now to FIG. 4, one embodiment of an interior air distribution plenum 51 for the air conditioning system 31 is shown. Plenum 51 is used to distribute chilled air at the front of the vehicle toward the driver and the front seat passenger (if any). The plenum 51 incorporates several unique design features. For example, in one embodiment, the plenum is vertically flush with a lower edge 53 (FIG. 5) of the windshield 55 so that the line of sight, views, and range of visibility of the driver and passengers are completely unobstructed by plenum 51 through the windshield 55. This advantage is particular important for shorter occupants of the vehicle.

In one embodiment, the driver is provided with a single ventilation outlet 57 (FIG. 4) through which air may be distributed directly in his or her direction. The consolidation of driver ventilation into the single outlet 57 reduces the horizontal width 61 (FIG. 5) of the plenum 51. The reduction in width 61 also provides the driver with greater clearance 63 between plenum 51 and the steering wheel 65 of the vehicle than is available with prior art designs. The single outlet 57 for direct cooling of the driver is oversized and provides a more concentrated flow of air at a greater velocity than typical, multi-vent plenum designs. One or more movable defrost plate(s) 67 may be used to defrost windshield 55, and one or more outlets 69 (FIG. 4) are provided for the front seat passenger.

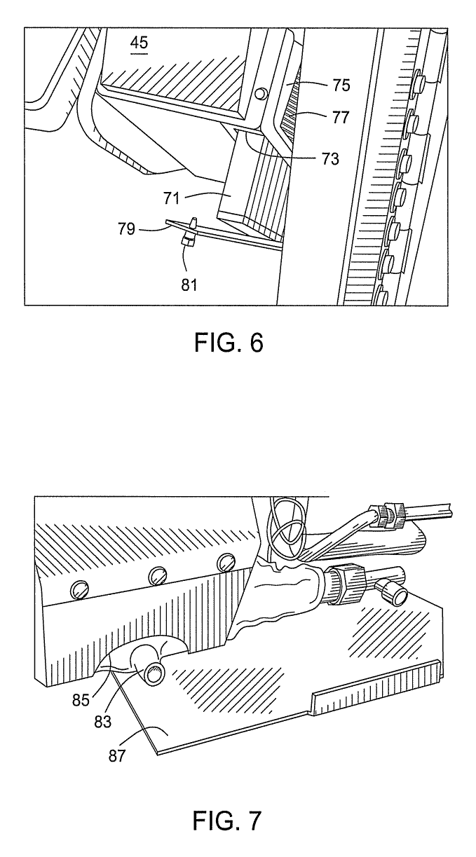

Referring now to FIG. 6, a portion of the interior cabin of the vehicle is shown, specifically, just above the footwell of the front seat passenger. In the embodiment shown, the front evaporator 45 is positioned adjacent this location and is equipped with a renewable (e.g., washable with water) filter 71. The filter 71 installs adjacent the evaporator 45 in an inclined, vertical orientation as shown through an aperture 73 formed in the lower surface of a housing 75 thereof. When positioned in housing 75, air from the cabin enters an opening 77 in the housing 75 and is filtered by filter 71. The filter 71 is retained in housing 75 by an access panel (e.g., thin rectangular plate) 79 that extends along the lower edge of filter 71 and housing 75. The plate 79 is retained on housing 75 by a pair of threaded fasteners 81 having enlarged heads that can be installed/removed by hand or with tools (e.g., a screwdriver).

As shown in FIG. 7, a plastic drain port 83 extends from the air conditioning system for discharging condensation produced by the system. The drain port 83 and drain tube (not shown) extend through an opening in the metal evaporator case support bracket 85. A kick plate 87 protects the port 83 and drain tube from incidental contact and damage by the feet of an occupant seated adjacent thereto.

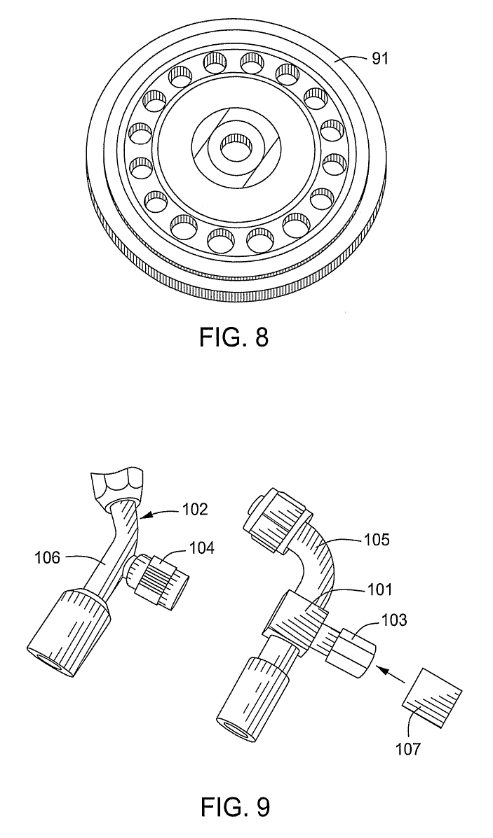

Referring now to FIG. 8, the compressor 41 utilizes a bar stock valve plate 91 therein for improved durability of the air conditioning system 31. The valve plate 91 rests inside the cylinder of the compressor at the top of the piston travel (i.e., the cylinder head). Traditionally, valve plates are formed from powdered metal. However, the solid metal bar stock valve 91 of the present invention solves many of the compressor failures associated with conditions known as liquid refrigerant and oil slugging. Slugging comprises incompressible liquid refrigerant and oil being introduced into the cylinder during operation. This condition causes prior art powdered metal plates to fracture, but does not affect the bar stock plate 91 of the present invention.

FIG. 9 illustrates an improved block joint and fitting 101 of the present invention. In one embodiment, the air conditioning system uses tubing 105 (e.g., on the order of ⅝-inch diameter) that is brazed to a charging port 103 for introducing refrigerant into the system. In prior art designs (see assembly 102), the charging port 104 is brazed directly to the tubing 106, which can place undue stress on the brazed joints of tubing 106. However, fitting 101 is constructed as a sturdy block of material to which the tubing 105 is attached in a more resilient configuration. The charging port 103 extends from fitting 101 such that stress due to attachment of a heavy hose connector 107 to charging port 103 is accommodated by fitting 101, rather than by the brazed joints of tubing 106. This design is far more resilient and the potential for leakage is greatly reduced.

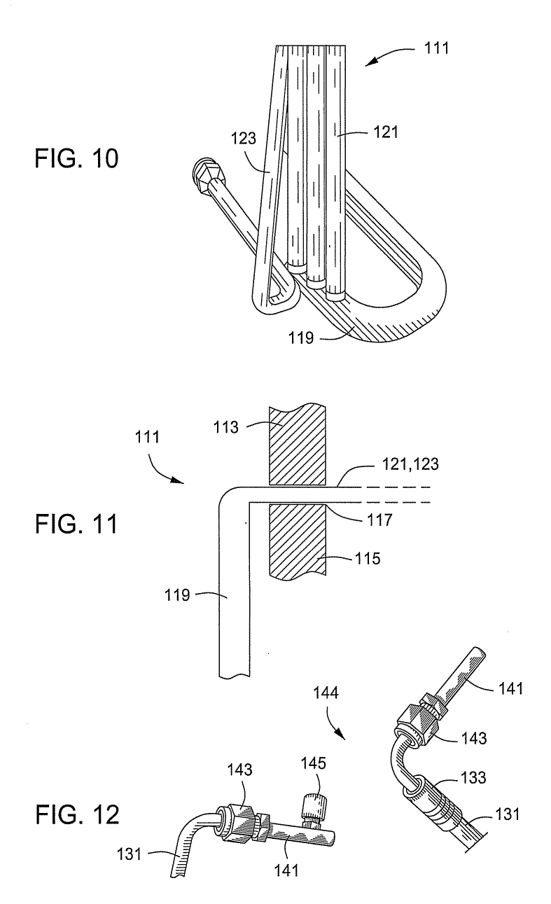

Referring now to FIGS. 10 and 11, one embodiment of tubing manifold 111 for an armored vehicle is shown. To protect the occupants in an armored vehicle, the plates 113, 115 (FIG. 10) of armor must be relatively closely toleranced. Any openings or seams in the armor, such as opening 117 (FIG. 11), must remain small to avoid exposing the occupants of the vehicle to hazardous projectiles, explosions, etc. However, in some embodiments, the refrigerant used by the air conditioning system 31 must be passed from an exterior of the cabin to the interior of the cabin and, therefore, must pass through the armor plates 113, 115. In some vehicles, the opening 117 is only approximately ⅜-inch wide. Since some air conditioning systems require tubing of at least ⅝-inch to adequately circulate refrigerant and thereby cool the interior cabin, the manifold 111 of the present invention splits a large (e.g., ⅝-inch) tube 119 into multiple (three shown) smaller (e.g., about ⅜-inch) tubings 121 to provide an adequate return path for the gaseous-phase refrigerant. The outgoing liquid-phase refrigerant is adequately accommodated by a similar small diameter tube 123.

FIG. 12 depicts a unique hose construction according to the present invention. A hose 131 is shown with a crimp fitting 133. Due to the extreme conditions experienced in warfare and the harsh conditions under which maintenance is performed on the vehicle, the crimp fitting 133 is configured to provide and accommodate an unusually large crimp depth. For example, the crimp depth for a #6 refrigerant hose (i.e., high pressure liquid refrigerant having a 5/16-inch inner diameter) is 0.530+/−0.010 inches.

FIG. 12 also depicts one embodiment of a system and method for an extended pressure decay test. The test is available for all components of the air conditioning system, such as evaporator assemblies, condenser, and hoses. For example, sealed fittings 141 are joined (e.g., threaded) into the fittings 143 on the ends of a finite length of the hose 131. A pressurized holding charge (e.g., helium, etc.) is then applied to the sealed assembly 144 formed by fittings 141. One of the sealed fittings 141 is provided with a charging port 145 through which the initial charge is detected and recorded in some form. The assembly 144 is then shipped to a customer thereof. This time delay may range anywhere from hours to weeks. Upon receipt, the customer (i.e., not the manufacturer) inspects the assembly 144 and measures the pressure therein via port 145. If the component still holds substantially the same pressure it was initially charged to, the component passes the extended pressure decay test. If not, some form a leak has occurred and the component may be in need of repair prior to installation.

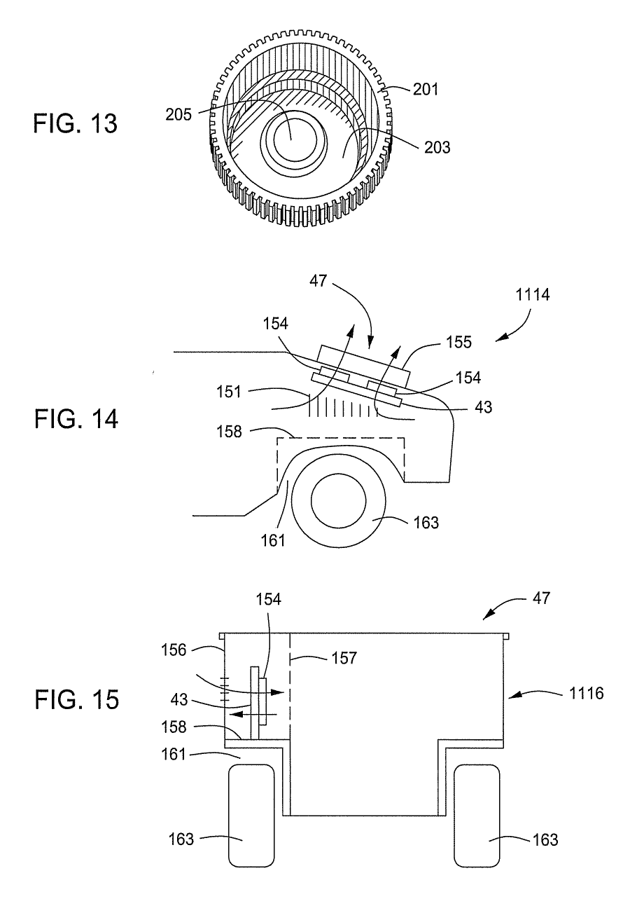

As shown in FIG. 13, the present invention also comprises a unique charging port cap 201 having an internal gasket 203 that is captured therein. The outer diameter of the gasket 203 is captured in a radial slot formed in the inner wall of the cap 201 that is defined by shoulders located axially above and below the gasket 203. Moreover, the axially centered protrusion 205 also may be fitted with a shoulder for capturing an inner diameter of gasket 203. This design avoids accidental removal or dislodging of the gasket 203 from the cap 201. Such mishaps are relatively common among caps having gaskets that are merely pressed into place and not captured inside the cap 201.

Referring now to FIGS. 1 and 14, one embodiment of a field serviceable condenser design is shown. FIG. 1 depicts model 1114 and includes a door 151 that is hinged 153 along its upper length to provide access to the condenser 43 (FIG. 14) located inside the rear storage compartment 47 of model 1114. Door 151 can swing open 180 degrees (i.e., vertically upward) for complete access and cleaning of condenser 43. In this embodiment, the condenser 43 is inclined (at the roof angle of compartment 47—see FIG. 14) but substantially in a horizontal plane. One or more electric fans 154 are mounted to condenser 43 (e.g., on its top surface) for pulling air (see arrows) into compartment 47 through the vents or louvered panel in door 151, through the coils of condenser 43, and then exhausting the heated air through the grill 155 located on the upper surface of compartment 47.

In another embodiment (model 1116 of FIGS. 2 and 15), the condenser 43 is vertically oriented adjacent the intake vents in the side wall 156 of the compartment 47. One or more electric fans 154 are located on an opposite side of the condenser 43 and the entire assembly is accessible through a removable panel 157 on one side of the interior of the compartment 47.

Because of the large amount of dust and debris circulated during use of the vehicle in adverse and hostile conditions, the fans are intermittently reversed (see arrows) at selected intervals (e.g., for 10 seconds once every hour, in one embodiment) to purge any accumulated dust and/or debris lodged on the inlet side of condenser 43. In one embodiment, this fan reversal sequence is automated and is pre-programmed to occur on each start-up of the vehicle and/or system.

In the embodiments shown (e.g., models 1114 and 1116), the entire condenser assembly is located within the rear storage compartment 47. None of the components of the condenser assembly are located outside of this compartment 47. In particular, none of the components of the condenser assembly are located below the partition 158 (FIGS. 14 and 15) that separates the interior of the compartment 47 from the wheel wells 161 in which the rear wheels 163 of the vehicle are located.

The condenser system is designed to be isolated from road hazards such as mud and rocks, and the vertical travel of the rear wheels 163. In one application, the condenser 43 incorporates several features for more efficient operation in harsh environments. For example, one embodiment of the condenser 43 utilizes a tube and fin design for high pressure and durability, 10 fins per inch, and despite being a dual evaporator system, uses only one condenser to reduce the coupling points for both refrigerant and electrical requirements.

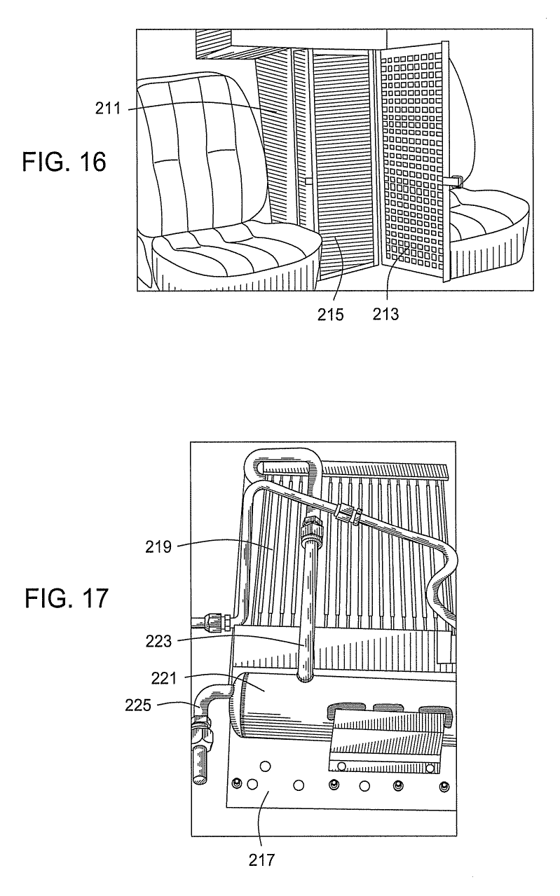

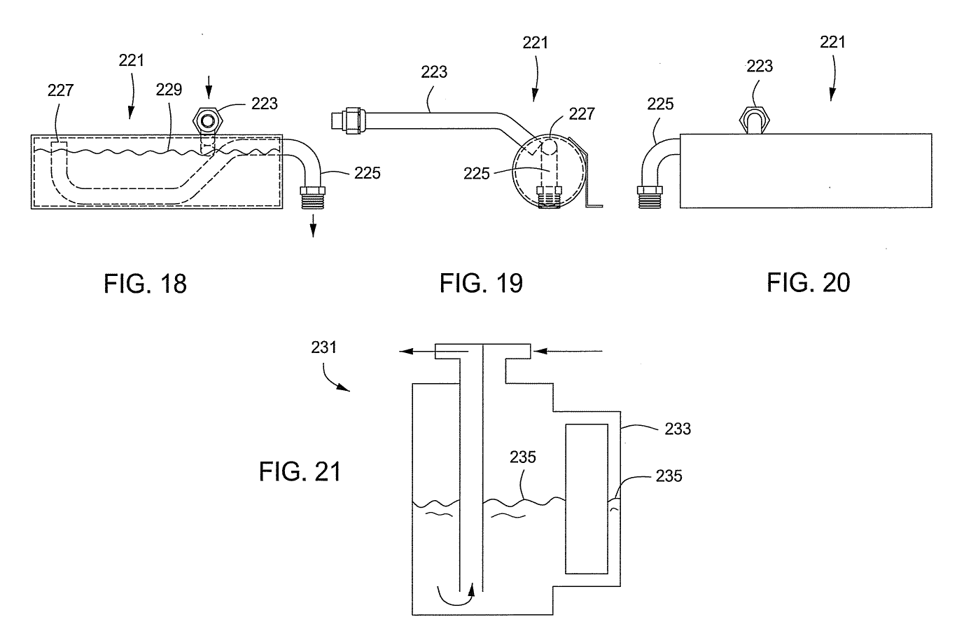

Referring now to FIGS. 16-20, various views of an evaporator system of the present invention for the vehicles is shown. In FIG. 16, a front view of the rear evaporator (i.e., installed between the seats for two rear occupants) illustrates a housing 211 having filter access door 213 open to access the rear, washable air filter 215. The backside 217 of housing 211 is shown in FIG. 17, having the evaporator 219 and a horizontal accumulator 221 mounted thereto, both of which are contained with the cooler environment of housing 211, rather than the ambient environment of compartment 47. The horizontal orientation of accumulator 221 also reduces the volumetric space requirements of the system. FIG. 18 depicts various views of the horizontal accumulator 221 having an inlet port 223 and outlet port 225. The inlet port 223 introduces various mixtures of gaseous and liquid refrigerant that settle within the tank of accumulator 221. The top opening 227 on outlet port 225 inside accumulator 221 is located in such a position as to provide a reservoir for accumulated liquid refrigerant 229 that collects in cool environment conditions.

FIG. 21 depicts one embodiment of a receiver and/or dryer 231 utilized by the air conditioning system of the present invention. Receiver 231 is used to receive the returning refrigerant prior to reentry into the compressor as is known in the art. Receiver 231 is equipped with a sight tube 233 that provides a visual indication of the liquid level 235 of the refrigerant inside receiver 231. One embodiment of sight tube 233 extends between the lower and upper ends of receiver 231 and is at least partially transparent or translucent to permit viewing of liquid level 235. Alternatively, sight tube 233 may be provided with a “window” for the same purpose.

While the invention has been shown or described in only some of its forms, it should be apparent to those skilled in the art that it is not so limited, but is susceptible to various changes without departing from the scope of the invention.

What is claimed is:

1. A climate control system for air conditioning and ventilating an interior of a vehicle, comprising:
a refrigeration system for cycling a refrigerant between a plurality of compressors, at least one condenser, and a plurality of evaporators, the evaporators being adapted to be spaced apart from each other on opposite ends of the vehicle; and
a plenum for distributing air flow and having a single ventilation outlet for a driver for distributing air flow in a direction of the driver, a plurality of ventilation outlets for passengers for distributing air flow in directions of the passengers, and a plurality of movable defrost plates on top of the plenum for defrosting a windshield.

2. A climate control system according to claim 1, wherein the evaporators comprise two evaporators, the condenser comprises a single condenser configured in a tube and fin design having about 10 fins per inch, and the compressors have valve plates formed from solid metal bar stock.

3. A climate control system according to claim 1, wherein at least one of the evaporators is equipped with a renewable air filter located in a housing in an inclined vertical orientation, and the renewable air filter is accessed via an access panel in a lower portion of the housing.

4. A climate control system according to claim 1, wherein the refrigeration system comprises a fitting having a block joint, ⅝-inch diameter tubing, a charging port extending from the block joint for introducing refrigerant into the refrigeration system; and further comprising:
a cap for the charging port, the cap having a gasket with an outer diameter that is captured in a radial slot formed in an inner wall of the cap that is defined by shoulders located axially above and below the gasket, the cap also having an axially centered protrusion fitted with a shoulder for capturing an inner diameter of the gasket.

5. A climate control system according to claim 1, wherein the refrigeration system comprises a tubing manifold having a main tube of at least ⅝-inch diameter, and a plurality of ⅜-inch tubes extending therefrom.

6. A climate control system according to claim 1, wherein the refrigeration system comprises a hose for high pressure liquid refrigerant having a 5/16-inch inner diameter and crimp fittings, each with a crimp depth of about 0.530+/−0.010 inches; and further comprising a test for extended pressure decay for components of the climate control system, the test comprising the steps of:
joining sealed fittings to the crimp fittings on ends of the hose to form a sealed assembly;
providing the sealed fittings with a charging port;
pressurizing the sealed assembly with an initial holding charge;
detecting and recording the pressurized initial holding charge;
waiting for a selected period of time to define a time delay; and
inspecting the sealed assembly after the time delay, measuring a pressure therein via the charging port, and comparing the pressure to the initial holding charge to determine if the pressure is substantially equivalent to the initial holding charge such that the sealed assembly passes the test.

7. A climate control system according to claim 1, wherein the condenser has a fan that is intermittently reversed at selected intervals to purge any accumulated debris lodged on an inlet side of condenser, and wherein a fan reversal schedule is automated and pre-programmed to occur for a few seconds for every hour of operation of the climate control system.

8. A climate control system according to claim 1, wherein the evaporator comprises a housing having a filter access door for providing access to a washable air filter, a horizontal accumulator located in the housing, the horizontal accumulator has an inlet port for introducing various mixtures of gaseous and liquid refrigerant that settle within a tank of the horizontal accumulator, an outlet port having a top opening inside the tank adjacent an upper end of the tank; and wherein the climate control system further comprises:
a receiver/dryer for receiving returning refrigerant prior to reentry into the compressor, the receiver/dryer having a sight tube for providing a visual indication of a liquid level of the refrigerant inside the receiver/dryer.

9. A vehicle, comprising:
an engine compartment;
a rear cargo area located opposite the engine compartment;
an interior cabin adapted to seat a driver and passengers located between the engine compartment and the rear cargo area;
a climate control system for air conditioning and ventilating the interior cabin, the climate control system having a refrigeration system for cycling a refrigerant between at least one compressor, at least one condenser, and at least one evaporator; and
the at least one evaporator is located between rear seats in the interior cabin and comprises a housing having a filter access door for providing access to a washable air filter, a horizontal accumulator located in the housing and spaced apart from the rear cargo area, the horizontal accumulator has an inlet port for introducing various mixtures of gaseous and liquid refrigerant that settle within a tank of the horizontal accumulator, an outlet port having a top opening inside the tank adjacent an upper end of the tank.

10. A vehicle according to claim 9, wherein the refrigeration system comprises two compressors, two condensers, and two evaporators, a front one of the evaporators is located in a forward portion of the vehicle and a rear one of the evaporators is located in a rear cargo area of the vehicle such that the evaporators are spaced apart from each other on opposite ends of the vehicle, and the compressors have valve plates formed from solid metal bar stock.

11. A vehicle according to claim 9, further comprising a plenum for distributing conditioned air from the climate control system, the plenum being vertically flush with a lower edge of a windshield of the vehicle such that a line of sight of the driver and passengers through the windshield are completely unobstructed by the plenum, the plenum having a single ventilation outlet for the driver for distributing air flow in a direction of the driver, a plurality of ventilation outlets for the passengers for distributing air flow in directions of the passengers, and a plurality of movable defrost plates on top of the plenum for defrosting the windshield.

12. A vehicle according to claim 9, wherein the interior cabin comprises a footwell for a front seat passenger, and a front evaporator is located adjacent the footwell and is equipped with a renewable air filter; and wherein the renewable air filter is located in a housing adjacent the front evaporator in an inclined vertical orientation, and the renewable air filter is accessed via an access panel in a lower portion of the housing.

13. A vehicle according to claim 9, wherein the refrigeration system comprises a fitting having a block joint, ⅝-inch diameter tubing, a charging port extending from the block joint for introducing refrigerant into the refrigeration system; and further comprising
a cap for the charging port, the cap having a gasket with an outer diameter that is captured in a radial slot formed in an inner wall of the cap that is defined by shoulders located axially above and below the gasket, the cap also having an axially centered protrusion fitted with a shoulder for capturing an inner diameter of the gasket.

14. A vehicle according to claim 9, wherein the vehicle has armor with an opening of about ⅜-inch, the refrigeration system comprises a tubing manifold having a main tube of at least ⅝-inch diameter, and a plurality of ⅜-inch tubes extending therefrom through the opening.

15. A vehicle according to claim 9, wherein the refrigeration system comprises a hose for high pressure liquid refrigerant having a 5/16-inch inner diameter and crimp fittings, each with a crimp depth of about 0.530+/−0.010 inches; and further comprising a test for extended pressure decay for components of the climate control system, the test comprising the steps of:
joining sealed fittings to the crimp fittings on ends of the hose to form a sealed assembly;
providing the sealed fittings with a charging port;
pressurizing the sealed assembly with an initial holding charge;
detecting and recording the pressurized initial holding charge;
waiting for a selected period of time to define a time delay; and
inspecting the sealed assembly after the time delay, measuring a pressure therein via the charging port, and comparing the pressure to the initial holding charge to determine if the pressure is substantially equivalent to the initial holding charge such that the sealed assembly passes the test.

16. A vehicle according to claim 9, wherein the condenser is located in the rear cargo area adjacent a condenser access door for access to and cleaning of the condenser, the condenser being inclined at a roof angle of the rear cargo area and having a fan mounted to an upper surface thereof for drawing air into the rear cargo area through vents in the condenser access door through coils of the condenser, and exhausting air heated by the condenser through a grill in a roof of the rear cargo area.

17. A vehicle according to claim 9, wherein the condenser is located in the rear cargo area in a vertical orientation adjacent intake vents in a side wall of the rear cargo area, a fan is located on the condenser opposite the intake vents, and the condenser is accessible through a removable panel adjacent the fan in an interior of the rear cargo area.

18. A vehicle according to claim 9, wherein the condenser has a fan that is intermittently reversed at selected intervals to purge any accumulated debris lodged on an inlet side of condenser; and wherein
a fan reversal schedule is automated and pre-programmed to occur at one of the following: (1) each start-up of the vehicle, and (2) for about 10 seconds for every hour of operation of the climate control system.

19. A vehicle according to claim 9, wherein the vehicle has rear wheels, wheel wells for the rear wheels, and partitions located between the rear cargo area and the wheel wells, and the condenser comprises a condenser assembly wherein an entirety of the condenser assembly is located within the rear cargo area above the partitions.

20. A vehicle according to claim 9, wherein the evaporator comprises two evaporators, the condenser comprises a single condenser configured in a tube and fin design having about 10 fins per inch; and the climate control system further comprises:
a receiver/dryer for receiving returning refrigerant prior to reentry into the compressor, the receiver/dryer having a sight tube for providing a visual indication of a liquid level of the refrigerant inside the receiver/dryer.

21. A method of extended testing of components for pressure decay, the method comprising:
(a) providing a hose with a crimp fitting on each end;
(b) joining a sealed fitting to each of the crimp fittings to form a sealed assembly;
(c) providing the sealed assembly with a charging port;
(d) pressurizing the sealed assembly with an initial holding charge;
(e) detecting and recording the pressurized initial holding charge;
(f) waiting for a selected period of time to define a time delay; and
(g) inspecting the sealed assembly after the time delay, measuring a pressure therein via the charging port, and comparing the pressure to the initial holding charge to determine if the sealed assembly is leaking.
